(19) United States
(12) Patent Application Publication
(10) Pub. No.: US 2009/0035107 A1
(43) Pub. Date: Feb. 5, 2009

(54) Tire Rotating Robot

(76) Inventors: Marlene Duran, Miami, FL (US); Michael Lopez, Miami, FL (US)

Correspondence Address: RUBEN ALCOBA, ESQ., 3399 NW 72 AVENUE, SUITE211, MIAMI, FL, 33122, US

(21) Appl. No.: 11/833,111

(22) Filed: Aug. 2, 2007

(51) Int. Cl. B60B 29/00; B25J 15/02; B25J 9/16

(52) U.S. Cl. 414/426; 901/3; 901/24; 901/41; 901/47

(57) ABSTRACT

A tire rotating robot used to rotate the tires of a vehicle. The robot can remove two tires sequentially without having a human to manually lift the tires. The robot for rotating tires comprises of a mobile base, a body connected to the base, a pivotally mounted two-position rotating beam connected to the body, two arm guide assemblies displaced within a channel of the beam, a motor that powers the robot, and an interface that controls the robot.

### BACKGROUND

The present invention is directed to a robot for rotating tires that removes two tires sequentially without having to manually lift the tires. The robot aids in the removal of tires from vehicles. The robot aids a tire changer from having to manually lift the tires when rotating the tires of a vehicle.

The current method of removing and rotating tires in a garage is as follows: lifting a vehicle on a lift: loosening and removing the lugnuts from the bolts of the tires; manually removing the tires from the hubs: rotating the tires of the vehicle; and lastly, manually mounting and securing the tires on the hubs.

The current method of rotating tires requires the tire chanter to have sufficient strength to lift the tires when removing and mounting the tires on the hubs. The current method invites injury, for tires are not light. Often, tire changers hurt their backs when lifting tires.

Information relevant to attempts to address these problems can be found in U.S. Pat. Nos. 3,830,387 and 4,042,139. However, each one of these references suffers from one or more of the following disadvantages: the inventions do not eliminate the need to manually lift each tire when rotating two tires, for the devices do not secure two tires simultaneously.

An object of the present invention is to provide a device that will minimize the lifting of tires when rotating the tires of a vehicle.

Another object of the present invention is to provide a device that can hold two tires at the same time.

Another object of the present invention is to provide an automated device for removing tires from a vehicle.

A further object of the present invention is to provide an inexpensive robot to rotate tires.

A further object of the present invention is to provide a device that will minimize injuries associated with rotating tires.

### SUMMARY

The present invention is directed to a robot for rotating tires that satisfies the need of not having to manually lift tires when rotating the tires of a vehicle. The robot for rotating tires comprises of a mobile base. The base defines a body guide. A body, the body is mounted on the base's body guide. The body houses a motor and defines a pivoting point. The motor connects to all the elements of the robot needing power. An interface attached to the body, The interface connects to all of the functioning elements of the robot. A two position-rotating beam is centrally attached to the body at the pivoting point. The beam defines a channel. A medium servomotor is attached to the beam. Two arm guide assemblies, each arm guide assembly comprising of a beam attaching guide and three arm guides. Each beam attaching guide is housed within the channel of the beam and is controlled by the medium servomotor. The arm guides are equally separated from each other and concentric to a pivot, the pivot attaches to the beam attaching guide. Each arm guide defines an arm channel guide. A plurality of levers, each lever has two ends, the first end of each lever is housed within each arm channel guide. A plurality of small servomotors, each small servomotor attaches to each arm guide. A plurality of tire grips, each tire grip attaches to each lever's second end. A plurality of pneumatic activators, each activator attaches to each arm guide.

An embodiment of the present invention might further comprise of a plurality of casters displaced on the bottom of the base.

Another embodiment of the present invention might comprise of guide rails being attached to the bottom of the base.

In a preferred embodiment of the present invention, the invention might further comprise of a plurality of infrared sensors, each infrared sensor shall be attached to each lever.

The present invention is used by imputing the specifications of the tires to be changed into the interface. Then positioning the first arm guide assembly of the present invention over the tire to be changed/rotated. Then instructing the present invention to clamp the tire. Then removing the lugnuts of the tire. Then removing the tire. Then rotating the rotating beam so that the second arm guide assembly is over the second tire to be changed/rotated and repeating the steps described above to remove the first tire.

### DRAWINGS

These and other features, aspects, and advantages of the present invention will become better understood with regard to the following description, appended claims, and drawings where:

FIG. 1 shows a perspective view of a tire rotating robot holding a tire;

FIG. 2 shows a perspective view of the tire rotating robot mounted on casters;

FIG. 3 shows a perspective view of the tire rotating robot mounted on floor guides;

FIG. 4 shows a side view of the tire rotating robot;

FIG. 5 shows a front view of the tire rotating robot holding a tire;

FIG. 6 shows a rear view of the tire rotating robot;

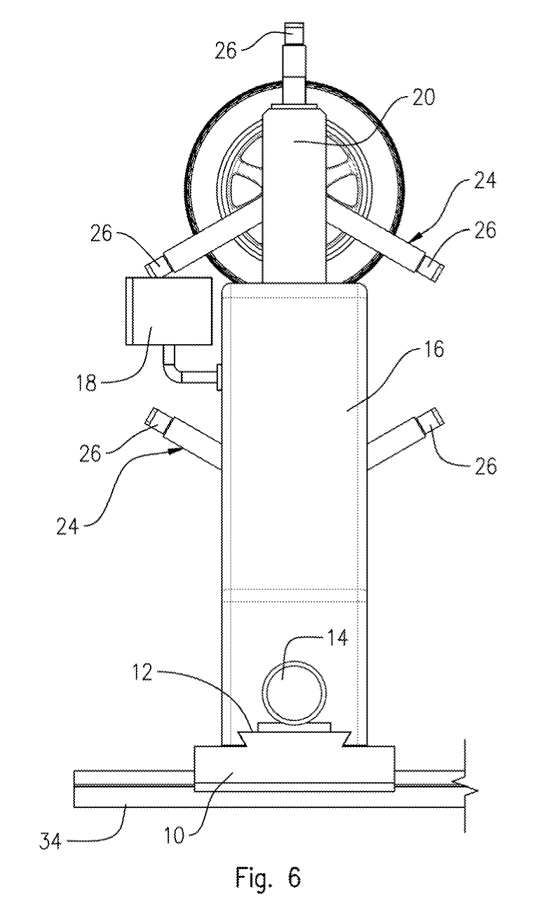

FIG. 7 shows another front view of the tire rotating robot;

FIG. 8 shows another rear view of the tire rotating robot;

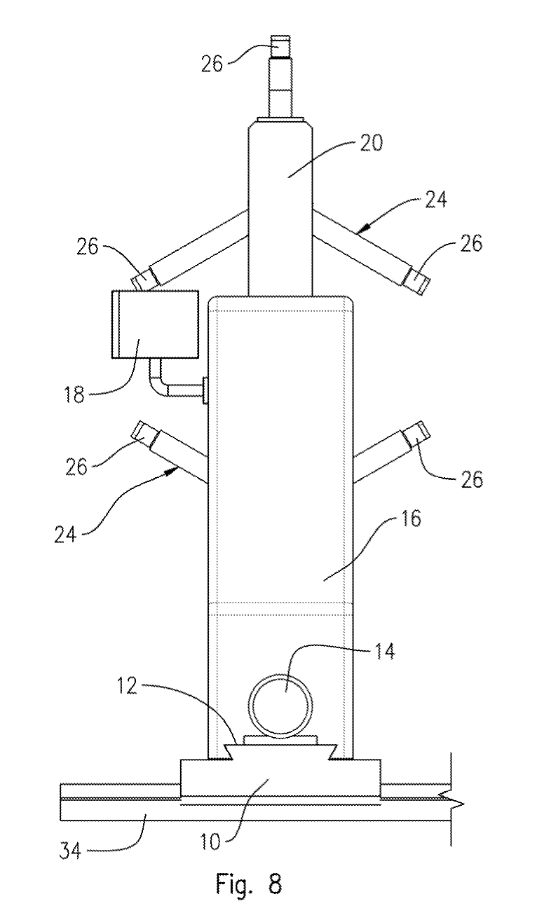

FIG. 9 shows a top view of the tire rotating robot;

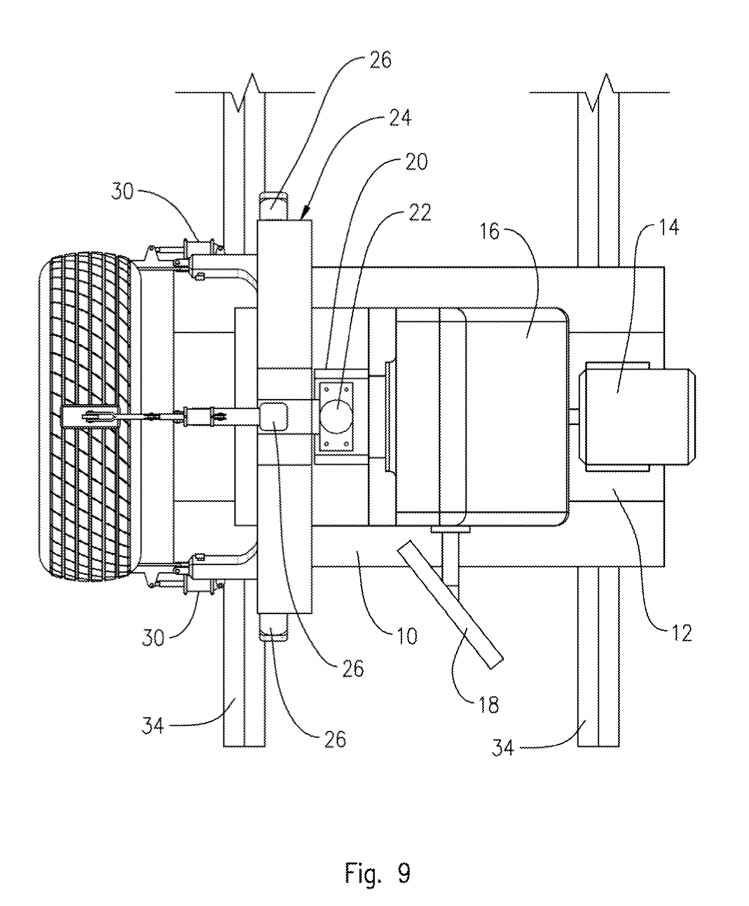

FIG. 10 shows an exploded view of one of the levers, grip pads, infrared sensors and pneumatic actuators of the tire rotating robot and their connectivity;

FIG. 11 shows an exploded view of one of the arm guide assemblies of the tire rotating robot comprising a socket gun assembly; and

FIG. 12 shows a perspective of the tire rotating robot mounted on roof guides.

### DESCRIPTION

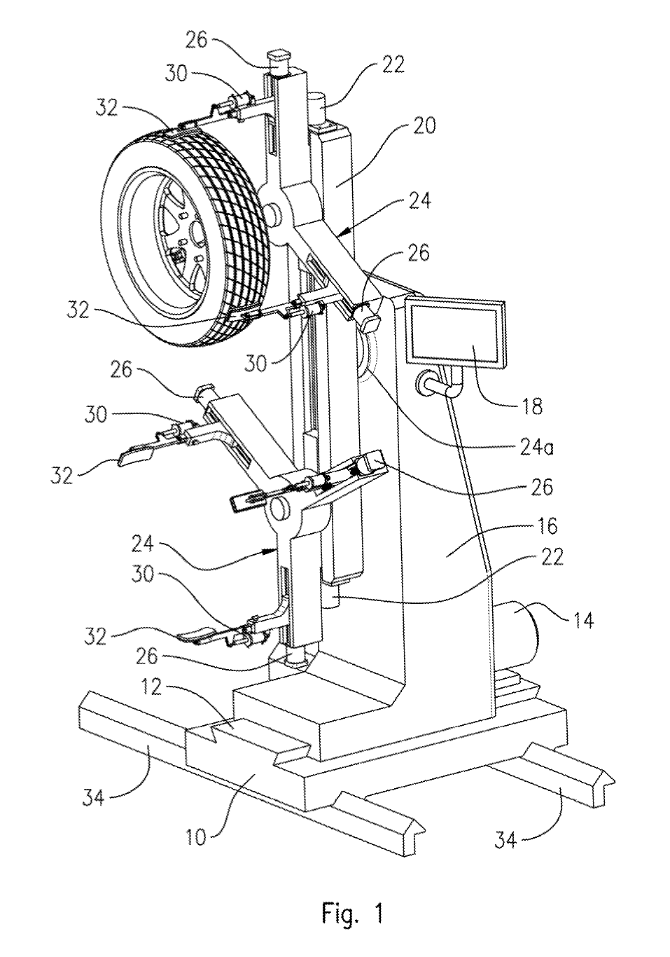

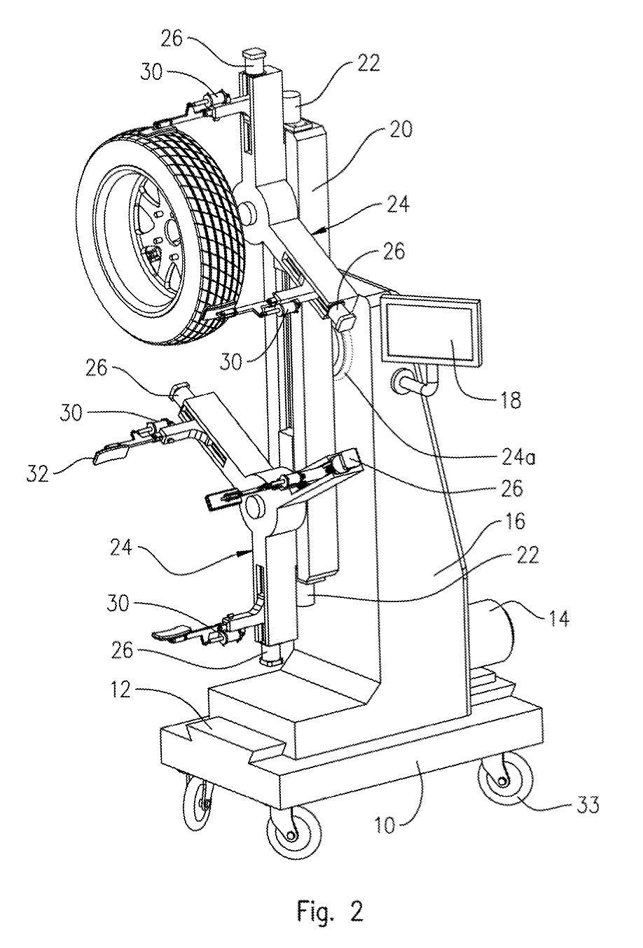

As seen in FIGS. 1 and 2, a robot for rotating tires comprises a mobile base 10. The mobile base 10, has a top and a bottom side, the top side of the base 10 defines a body guide 12. A body 16, the body 16 has a top and a bottom side. The bottom side of the body 16 mounts the base body guide 12. A pivotally mounted two-position rotating beam 20 centrally attached to the top side of the body 16, wherein the beam 20 defines a channel. A medium servomotor 22 attached to the top end of the beam 20. A pair of arm guide assemblies 24 linearly displaced within the channel of the two-position rotating beam 20. An interface 18 attached to the body 16 and connected to the medium servomotor 22 and to each arm guide assembly 24. And, a motor 14 attached to the body 16 and connected to the interface 18.

As seen in FIG. 2, in an embodiment of the present invention, a plurality of casters 33 attaches to the bottom of the base 10. As seen in FIG. 1, 3-9, and 12, in another embodiment of the present invention, either a floor or roof guide 34 attaches to the bottom of the base 10. The casters 33 or the guides 34 allow the robot to be moved to a position that allows the robot to remove tires from a vehicle.

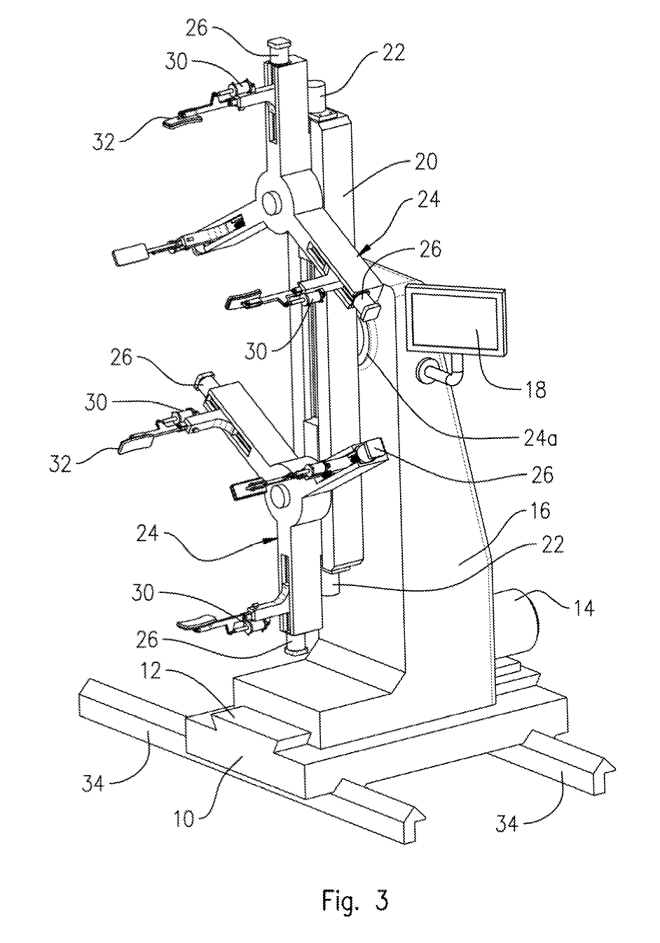

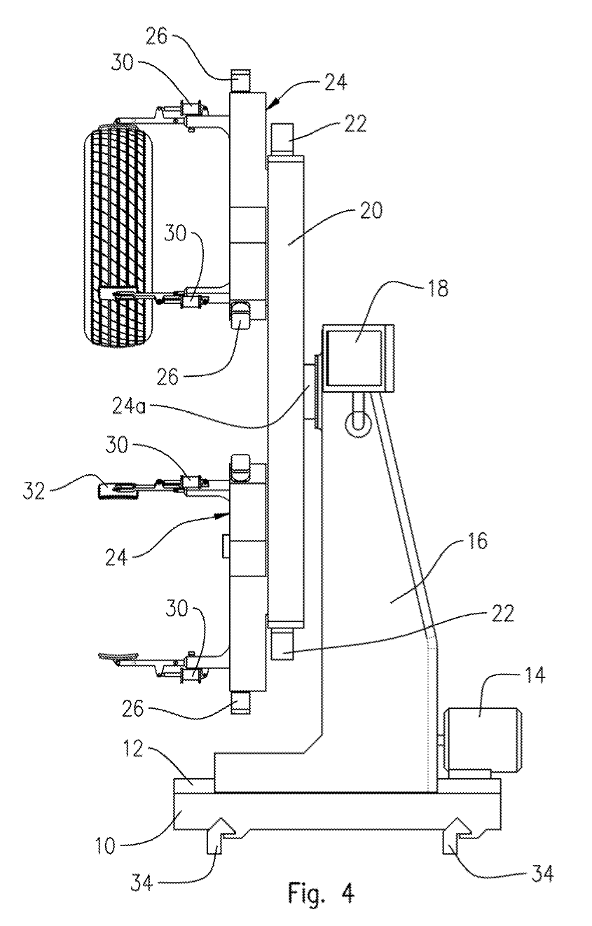

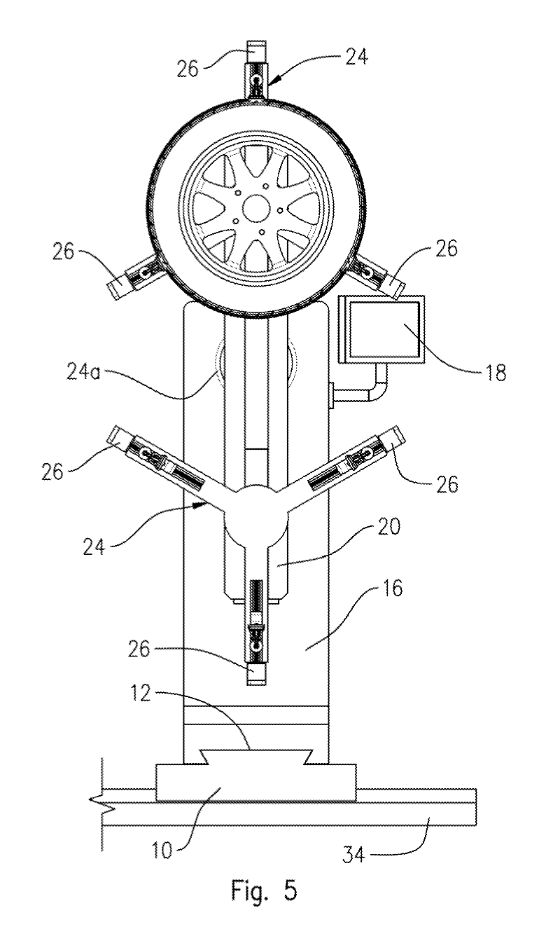

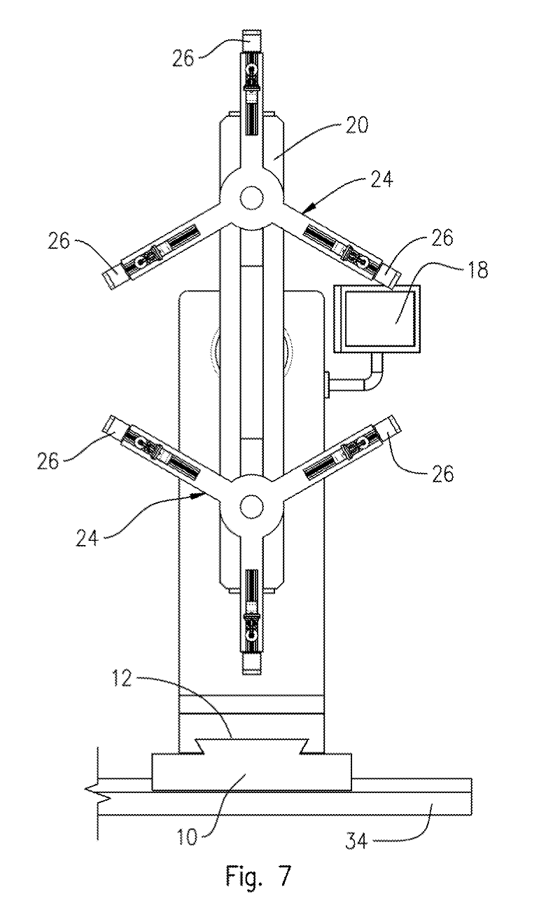

As seen in FIGS. 1-5, 7, 10-12, each am guide assembly 24 comprises of three arm guides 24a that are equally separated from each other and concentric to a pivot 24b, the pivot 24b attaches to a beam attaching guide 24c. and each arm guide 24a defines an arm guide channel 25. A plurality of levers 27, each lever 27 having two ends, the first end is housed within the arm guide channel 25. A plurality of second servomotors 26, each second servomotor 26 attaches to each arm guide 24a. A plurality of tire grips 32, each tire grip 32 attaches to each lever's second end 27. A plurality of pneumatic activators 30, each activator 30 attaches to each lever 27.

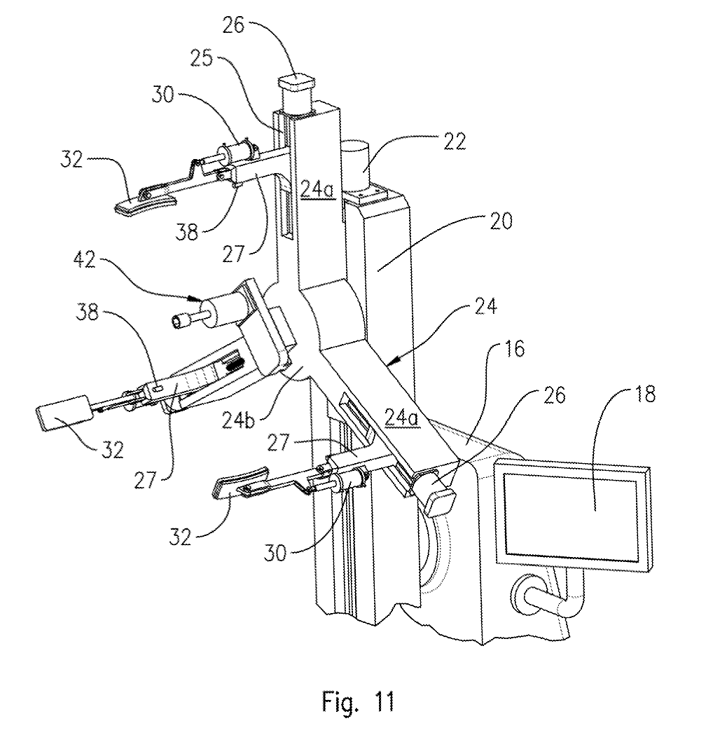

As seen in FIG. 11, an embodiment of the present invention might further comprise of a plurality of infrared sensors 38, each infrared sensor shall be attached to each lever 27.

As seen in FIG. 11, in another embodiment of the present inventions, the robot might further comprise of a pair of socket gun assemblies 42, each socket gun assembly 42 attaches to each arm guide assembly 24 and to the interlace 18.

The tire rotation robot is designed to interchange the front and back tires of a vehicle automatically. To achieve its purpose, the robot has several movements that are controlled by a microprocessor. This microprocessor is programmed to receive information from different sensors and from the user input/interface 18 in order to coordinate the necessary combination of movements to achieve a proper positioning/alignment.

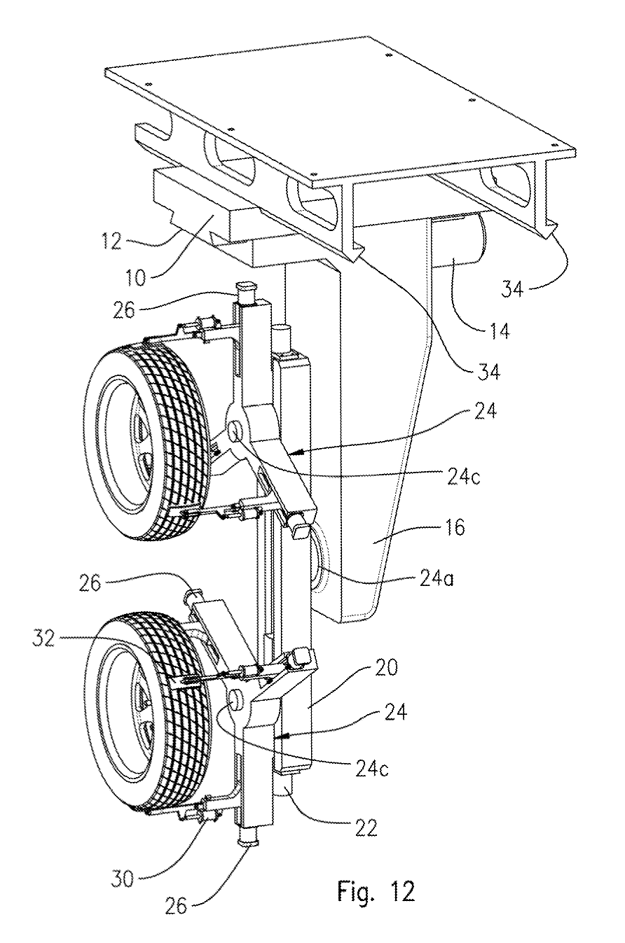

To achieve its objective, the robot has to have the ability to align one of the arm guide assemblies 24 to position that is concentric to the tire. Because of the particular degrees of freedom of the robot, this requires movements in the X, Y and Z axis. As shown in FIGS. 1 and 12, in its automatic version, the entire robot displaces along a set of floor or roof guides 34 and the movement occurs along the side of the vehicle which tire is shown. This aligns the robot clamping set of arms in the X-direction. As shown in FIG. 2, the semiautomatic version of the robot can be positioned using casters 3. The functionality of the automatic version is discussed below.

Before any moment occurs, the operator will enter the tire information in the interlace, the interface houses the microprocessor. This causes the microprocessor to send information to the small servomotors 26 located at each end of the each arm guide assembly. The robot then will move each lever 27 in or out simultaneously in order to position each lever 27 around a clamping diameter of the tire being removed.

Each arm guide assembly 24 can move farther or closer to the rotating beam pivoting point 24a. This movement guaranties the alignment in the Y-direction.

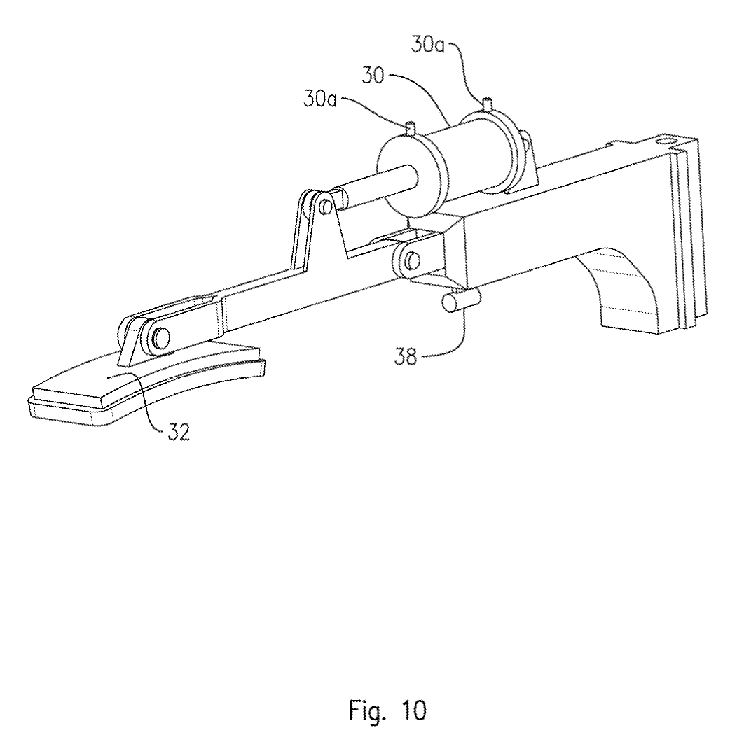

The combination of the X and Y movements described above causes each arm guide assembly to align concentric with the tire. As seen in FIGS. 10-11, each arm guide assembly 24 might have an infrared sensor 38 attached. The sensor 38 sends readings to the microprocessor. The microprocessor calculates the differences in reading between the three infrared sensor's 38 readings and dictates which direction the X and Y movements should go towards. The infrared sensor's readings are sent to the microprocessor again; this repeats as an iterative process that ends when each lever 27 is located at the edge of the tire, within the allowed precision. The entire process should take between three to five iterations.

Upon each of arm guide assembly 24 being positioned concentric with the tire, the body 16 will displace closer to the tire, until each tire grip 32 is adjacent to the tire. This aligns each arm guide assembly in the Z-direction. The movement is controlled by the microprocessor, since its program can calculate distances based on the infrared sensors' readings. Right after the tire grips are in the proper position, half an inch to one inch away from the tire, the air pressure is sent to the pneumatic actuators 30 to apply clamp force, and the tire grips 32 secure the tire.

As seen in FIG. 11, the next operation, which is the removal of the tire lugnuts, can either be done manually or automatically depending on the version of the robot. The automatic process requires a pair of socket-gun assemblies 42, each socket gun assembly might be mounted on each arm guide assembly. The socket gun assembly 42 might rotate about its center and might also displace so that the socket gun aligns with each lugnut. All of the movements might be controlled by the microprocessor.

With the tire loose and secured by the arm guide assembly 24, the body 16 will move outwards from the vehicle, in the Z-direction. At this point, the entire robot can move along the guides 34 towards the second tire. Once in proximity, the two positions rotating beam 20, can start rotating to switch positions between the arm guide assemblies.

The process to extract the second tire repeats as with the first tire. Then, the arms guide assemblies 24 are switched back bringing the first tire to the location of the second tire. The tire is installed either automatically or manually and the robot displaces to the location of the first tire, while rotating the two positions rotating beam 20. The tire from the second location is now ready to install in the first location, finalizing the process.

The operator might have the capability to move the robot along any axis manually using the controls in the interface 18. Also, information regarding vehicle and tire types can he stored in the microprocessor's memory and used to calculate traveling distances.

The rotation of the two positions rotating beam can he achieved using any transmission conventional method either mechanical or hydraulic.

An advantage of the present invention is that it provides a device that minimizes the lifting of tires when rotating the tires of a vehicle.

Another advantage of the present invention is that it provides a device that holds two tires at the same time.

Another advantage of the present intention is that it provides an automated device for removing tires from a vehicle.

A further advantage of the present invention is that it provides an inexpensive robot to rotate tires.

A further advantage of the present invention is that it provides a device that minimizes injuries associated with rotating tires.

Although the present invention has been described in considerable detail with reference to certain preferred versions thereof, other versions are possible. Therefore the spirit and the scope of the claims should not be limited to the description of the preferred versions contained herein.

What is claimed is:

1. A robot for rotating tires that removes two tires sequentially without having to manually lilt the tires, comprising:
a mobile base, having a top and a bottom side, the top side defines a body guide;
a body, having a top and a bottom side, the bottom side of the body mounted to the top side of the base;
a pivotally mounted two-position rotating beam centrally attached to the top side of the body, wherein the beam defines a channel;
a medium servomotor attached to the top end of the beam;
a pair of arm guide assemblies linearly displaced within the channel of the two-position rotating beam;
an interface attached to the body and connected to the medium servomotor and to each arm guide assembly; and
a motor attached to the body and connected to the interface.

2. The robot of claim 1, wherein each arm guide assembly comprises:
three arm guides equally separated from each other and concentric to a pivot,
wherein each arm guide defines an arm guide channel;
a beam attaching guide attached to the pivot;
a plurality of levers, each lever having two ends, and the first end is housed within the arm guide channel;
a plurality of second servomotors, each second servomotor attached to each arm guide;
a plurality of tire grips, each tire attached to each lever's second end, and
a plurality of pneumatic activators, each activator attached to each lever.

3. The robot of claim 2, further comprising a plurality of casters attached to the bottom of the mobile base.

4. The robot of claim 3, further comprising a plurality of infrared sensors, each infrared sensor attaches to each lever.

5. The robot of claim 4, further comprising, a pair of socket gun assemblies, each socket gun assembly attached to each arm guide assembly and to the interface.

6. The robot of claim 2, further comprising a floor or roof guide attached to the bottom of the base.

7. The robot of claim 6, further comprising a plurality of infrared sensors, each infrared sensor attaches to each lever.

8. The robot of claim 7, further comprising a plurality of socket gun assemblies, each socket gun assembly attached to each arm guide assembly and to the interface.

9. The robot of claim 2, further comprising a plurality of infrared sensors, each infrared sensor attaches to each lever.

10. The robot of claim 9, further comprising a pair of socket gun assemblies, each socket gun assembly attached to each arm guide assembly and to the interface.

11. A method of using the robot of claim 2 to rotate the tires of a vehicle, comprising the steps of:
imputing the specifications of the tires to be changed into the interface;
then positioning the first arm guide assembly over a vehicle's first tire to be changed/rotated;
then instructing the robot to clamp the first tire;
then removing the lugnuts of the first tire;
then removing the first tire;
then rotating the two position rotating beam so that the second arm guide assembly is over the vehicle's second tire to be changed/rotated; and
then repeating the steps described above to remove the first tire.
